(19) United States
(12) Patent Application Publication
(10) Pub. No.: US 2021/0189184 A1
(43) Pub. Date: Jun. 24, 2021

(54) ADHESIVE COMPOSITIONS

(71) Applicant: DIC Corporation, Tokyo (JP)

(72) Inventors: Mariko Tsunashima, Takaishi-shi (JP); Sin Sou, Takaishi-shi (JP); Keiji Tsunashima, Takaishi-shi (JP)

(73) Assignee: DIC Corporation, Tokyo (JP)

(21) Appl. No.: 17/055,692

(22) PCT Filed: Apr. 4, 2019
(86) PCT No.: PCT/JP2019/014934

§ 371 Date: Nov. 16, 2020

(30) Foreign Application Priority Data
Jun. 15, 2018 (JP) 2018-114553

(51) Int. Cl. C09J 7/24; C09J 11/06; C09J 133/02; C09J 133/10; C09J 133/26; C09J 7/38

(52) U.S. Cl. CPC C09J 7/24; C09J 11/06; C09J 7/38; C09J 133/10; C09J 133/26; C09J 133/02

(57) ABSTRACT

An object of the present invention is that the migration of a plasticizer is suppressed while high bond strength is ensured. An adhesive composition of the present invention includes an acrylic polymer (A), a tackifier resin (B) and a crosslinking agent (C). The acrylic polymer (A) includes units derived from a (meth)acrylic acid alkyl ester (a1), a nitrogen-containing (meth)acrylic monomer (a2) and a carboxyl-containing (meth)acrylic monomer (a3). The content of the tackifier resin (B) is not less than 20 mass % of the content of nonvolatile components. Not less than 40 mass % of the tackifier resin (B) is represented by a rosin tackifier resin (b1).

### TECHNICAL FIELD

The present invention relates to an adhesive composition.

### BACKGROUND ART

Adhesive sheets are used in a wide range of household and industrial fields such as in the manufacturing of various products including electronic devices and automobiles, and in electrical insulating materials and display/decorative fields. In particular, adhesive sheets having a soft PVC (polyvinyl chloride) substrate exhibit high adhesion with respect to curved surfaces and have high ink fixation properties, thus finding use in a wide range of fields such as display and decorative fields. Further, soft PVC is also used in automotive wiring members by virtue of its flexibility and electrical insulating properties, and is thus often an adherend to which an adhesive tape adheres.

Conventionally known adhesive sheets and tapes that have a PVC substrate or adhere to PVC have a problem in that the plasticizer in PVC migrates to the adhesive layer to cause a decrease in performance (a separation or a lift due to lowered bond strength and lowered cohesive strength) over time (especially at high temperatures and high humidities). To address this problem, Patent Literature 1 proposes an acrylic adhesive containing an acrylic resin and a plasticizer wherein the glass transition temperature of the acrylic resin is not less than −20° C. (see Patent Literature 1). Further, Patent Literature 2 proposes an adhesive composition that includes an acrylic copolymer which is a copolymer of an alkyl (meth)acrylate, a hydroxyl-containing vinyl monomer and a nitrogen-containing vinyl monomer, and at least one of aliphatic isocyanate compounds having two or more isocyanate groups and derivatives thereof (see Patent Literature 2).

These adhesives are resistant to plasticizers but unfortunately do not satisfy high bond strength that is practically required.

### CITATION LIST

### Patent Literature

PTL 1: Japanese Unexamined Patent Application Publication No. 2016-188282

PTL 2: Japanese Unexamined Patent Application Publication No. 2016-108399

### SUMMARY OF INVENTION

### Technical Problem

The present invention has been made in consideration of the circumstances discussed above. It is therefore an object of the present invention that the migration of a plasticizer is suppressed while high bond strength is ensured.

### Solution to Problem

After extensive studies, the present inventors have found that a combination of a specific acrylic polymer and a specific tackifier resin attains enhanced compatibility and can improve the uniformity of an adhesive layer, and, as a result, the adhesive layer can resist the migration of a plasticizer while ensuring high bond strength.

An adhesive composition of the present invention includes an acrylic polymer (A), a tackifier resin (B) and a crosslinking agent (C), wherein the acrylic polymer (A) includes units derived from a (meth)acrylic acid alkyl ester (a1), a nitrogen-containing (meth)acrylic monomer (a2) and a carboxyl-containing (meth)acrylic monomer (a3), the content of the tackifier resin (B) is not less than 20 mass % of the content of nonvolatile components, and not less than 40 mass % of the tackifier resin (B) is represented by a rosin tackifier resin (b1).

### Advantageous Effects of Invention

By using the adhesive composition of the present invention, an adhesive tape can be provided which, even when the substrate thereof is polyvinyl chloride, is free from the migration of a plasticizer and can ensure high bond strength.

### DESCRIPTION OF EMBODIMENTS

An adhesive composition of the present invention includes an acrylic polymer (A), a tackifier resin (B) and a crosslinking agent (C).

The acrylic polymer (A) has units derived from a (meth)acrylic acid alkyl ester (a1), a nitrogen-containing (meth)acrylic monomer (a2) and a carboxyl-containing (meth)acrylic monomer (a3).

Examples of the (meth)acrylic acid alkyl esters (a1) include (meth)acrylic acid alkyl esters in which an alkyl group is bonded to an ester bond. The number of carbon atoms in the alkyl group is preferably at least 1, more preferably not less than 3, and still more preferably not less than 4, and is preferably not more than 20, more preferably not more than 15, still more preferably not more than 12, further preferably not more than 10, and particularly preferably not more than 8.

Examples of the alkyl groups include linear alkyl groups such as methyl group, ethyl group, n-propyl group, n-butyl group, n-pentyl group, n-hexyl group, n-heptyl group, n-octyl group and n-nonyl group; and branched alkyl groups such as isopropyl group, isobutyl group, isopentyl group, neopentyl group, isohexyl group, isoheptyl group, isooctyl group and 2-ethylhexyl group.

The (meth)acrylic acid alkyl ester (a1) is preferably an acrylic acid alkyl ester.

The (meth)acrylic acid alkyl esters (a1) may be used singly, or two or more may be used in combination. Examples thereof include methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, heptyl (meth)acrylate, n-octyl (meth)acrylate, isooctyl (meth)acrylate, 2-ethylhexyl (meth)acrylate and nonyl (meth)acrylate.

In the acrylic polymer (A), the content of the units derived from the (meth)acrylic acid alkyl ester (a1) is preferably not less than 50 mass %, more preferably not less than 70 mass %, and still more preferably not less than 80 mass %, and is preferably not more than 99 mass %, and more preferably not more than 90 mass %.

In the (meth)acrylamide compound, the substituents on the nitrogen atom contained in the amide bond may be, for example, a hydrogen atom, a hydrocarbon group (preferably an aliphatic hydrocarbon group), a hydrocarbon group (preferably an aliphatic hydrocarbon group) substituted with —CO— in place of —CH₂—, and/or such a hydrocarbon group (preferably an aliphatic hydrocarbon group) substituted with a hydroxyl group in place of a hydrogen atom. When the nitrogen atom is substituted with two or more groups, these substituents may be linked together to form a ring including the nitrogen atom.

The number of carbon atoms in the hydrocarbon group (preferably an aliphatic hydrocarbon group) on the nitrogen atom contained in the amide bond is preferably at least 1, and is preferably not more than 10, and more preferably not more than 6.

One, or two or more kinds of nitrogen-containing (meth)acrylic monomers (a2) may be used. Examples thereof include (meth)acrylic compounds having a nitrogen-containing functional group; and (meth)acrylamide compounds.

Examples of the nitrogen-containing functional groups include amino group, monosubstituted amino groups, disubstituted amino groups and nitrile group. The (meth)acrylamide compounds may be any of (meth)acrylamide, N-monosubstituted (meth)acrylamide compounds and N,N-disubstituted (meth)acrylamide compounds.

The nitrogen-containing (meth)acrylic monomer (a2) is preferably a nitrogen-containing acrylic monomer.

The (meth)acrylate compounds having a nitrogen-containing functional group may be used singly, or two or more may be used in combination. Examples thereof include (meth)acrylonitrile, t-butylaminoethyl (meth)acrylate, dimethylaminoethyl (meth)acrylate and diethylaminoethyl (meth)acrylate.

The (meth)acrylamide compounds may be used singly, or two or more may be used in combination. Examples thereof include (meth)acrylamide; N-monosubstituted (meth)acrylamide compounds such as N-isopropyl(meth)acrylamide, N-(1,1-dimethyl-3-oxobutyl) acrylamide, N-methylol(meth)acrylamide, N-methoxymethyl(meth)acrylamide, N-butoxymethyl(meth)acrylamide, N-(2-hydroxymethyl)acrylamide and N-(2-hydroxyethyl)acrylamide; and N-disubstituted (meth)acrylamide compounds such as N-(meth)acryloylmorpholine, N-(meth)acryloylpiperidone, N-(meth)acryloylpiperidine, N-(meth)acryloylpyrrolidine, N-(meth)acryloyl-4-piperidone, N,N-dimethyl(meth)acrylamide, N,N-diethyl(meth)acrylamide, N,N-methylenebis(meth)acrylamide and N,N-dimethylaminopropyl(meth)acrylamide.

In particular, a monomer represented by the formula (1) is preferably included as the nitrogen-containing (meth)acrylic monomer (a2).

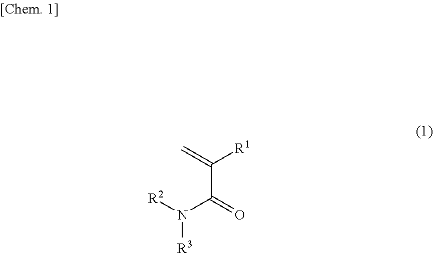

In the formula (1), R¹ denotes a hydrogen atom or a methyl group. R² and R³ each independently denote a hydrogen atom or a C1-C20 hydrocarbon group, and the hydrocarbon group may be substituted with —CO— in place of —CH₂— and may be substituted with a hydroxyl group in place of a hydrogen atom.

The hydrocarbon groups represented by R² and R³ may be of a single kind or of two or more kinds. Examples thereof include linear or branched, saturated aliphatic hydrocarbon groups; and linear or branched, unsaturated aliphatic hydrocarbon groups. In particular, linear or branched, saturated aliphatic hydrocarbon groups are preferable, and branched saturated aliphatic hydrocarbon groups are more preferable.

It is preferable that at least one of R² and R³ be a hydrogen atom.

In the units derived from the nitrogen-containing (meth)acrylic monomer (a2), the proportion of units derived from a (meth)acrylamide compound is preferably not less than 50 mass %, more preferably not less than 80 mass %, and still more preferably not less than 90 mass %, and is preferably 100 mass % or less.

In the units derived from the nitrogen-containing (meth)acrylic monomer (a2), the proportion of units derived from a monomer of the formula (1) is preferably not less than 50 mass %, more preferably not less than 80 mass %, and still more preferably not less than 90 mass %, and is preferably 100 mass % or less.

In the acrylic polymer (A), the content of the units derived from the nitrogen-containing monomer (a2) is preferably not less than 1 mass %, more preferably not less than 3 mass %, and still more preferably not less than 5 mass %, and is preferably not more than 30 mass %, more preferably not more than 20 mass %, and still more preferably not more than 15 mass %.

One, or two or more kinds of carboxyl-containing (meth)acrylic monomers (a3) may be used. Examples thereof include unsaturated monocarboxylic acids such as (meth)acrylic acid, carboxyethyl (meth)acrylate, carboxypentyl (meth)acrylate and β-carboxyethyl (meth)acrylate.

In the acrylic polymer (A), the content of the units derived from the carboxyl-containing (meth)acrylic monomer (a3) is preferably not less than 0.1 mass %, more preferably not less than 0.5 mass %, and still more preferably not less than 1 mass %, and is preferably not more than 20 mass %, more preferably not more than 10 mass %, and still more preferably not more than 5 mass %.

The acrylic monomer (A) may include units derived from an additional monomer (ax) other than the (meth)acrylic acid alkyl esters (a1), the nitrogen-containing (meth)acrylic monomers (a2) and the carboxyl-containing (meth)acrylic monomers (a3).

One, or two or more kinds of additional monomers (ax) may be used. Examples thereof include hydroxyl-containing (meth)acrylic monomers; epoxy ring-containing (meth)acrylic monomers such as glycidyl (meth)acrylate; alicyclic (meth)acrylic monomers such as cyclohexyl (meth)acrylate; aromatic vinyl monomers such as styrene, o-methylstyrene, m-methylstyrene, p-methylstyrene, ethylvinylbenzene, α-methylstyrene, p-methoxystyrene, p-tert-butylstyrene, p-phenylstyrene, o-chlorostyrene, m-chlorostyrene, p-chlorostyrene and parahydroxystyrene; heterocyclic vinyl monomers such as N-vinylpyrrolidone, N-vinylcaprolactam and (meth)acryloylmorpholine; and monomers having two or more vinyl groups.

Examples of the hydroxyl-containing (meth)acrylic monomers include (meth)acrylic acid alkyl esters hydroxylated at the alkyl group; and (meth)acrylic acid polyalkylene glycol esters. (Meth)acrylic acid alkyl esters hydroxylated at the alkyl group are preferable, and (meth)alkyl acid alkyl esters hydroxylated at the terminal of the alkyl group are more preferable.

The hydroxyl-containing (meth)acrylic monomers preferably have one hydroxyl group.

The hydroxyl-containing (meth)acrylic monomers are preferably hydroxyl-containing acrylic monomers.

Examples of the acrylic acid alkyl esters include those compounds mentioned as examples of the (meth)acrylic acid alkyl esters (a1).

The hydroxyl-containing (meth)acrylic monomers may be used singly, or two or more may be used in combination. Examples thereof include hydroxylalkyl (meth)acrylates such as 2-hydroxylethyl (meth)acrylate, 2-hydroxylpropyl (meth)acrylate, 2-hydroxylbutyl (meth)acrylate and 4-hydroxylbutyl (meth)acrylate; and polyethylene glycol (meth)acrylate.

In the acrylic polymer (A), the content of the units derived from the hydroxyl-containing (meth)acrylic monomer is preferably not less than 0.01 mass %, more preferably not less than 0.02 mass %, and still more preferably not less than 0.03 mass %, and is preferably not more than 10 mass %, more preferably not more than 5 mass %, and still more preferably not more than 1 mass %.

In the acrylic polymer (A), the content of the units derived from the additional monomers (ax) is preferably 0 mass % or more, and is preferably not more than 20 mass %, more preferably not more than 10 mass %, and still more preferably not more than 5 mass %.

The weight average molecular weight of the acrylic polymer (A) is preferably not less than 100,000, more preferably not less than 200,000, and still more preferably not less than 300,000, and is preferably not more than 1,000,000, more preferably not more than 900,000, and still more preferably not more than 800,000.

In the present specification, the number average molecular weight and weight average molecular weight of the acrylic polymer (A) are values measured by gel permeation chromatography (GPC) using polystyrenes as standard samples.

In the adhesive composition of the present invention, the content of the acrylic polymer (A) is preferably not less than 30 mass %, more preferably not less than 50 mass %, and still more preferably not less than 60 mass %, and is preferably not more than 95 mass %, more preferably not more than 90 mass %, and still more preferably not more than 85 mass % of the content of nonvolatile components.

In the present specification, the content of nonvolatile components in the adhesive composition means the proportion of components except a solvent component contained in the adhesive composition as required.

The acrylic polymer (A) may be produced by copolymerizing the (meth)acrylic acid alkyl ester (a1), the nitrogen-containing (meth)acrylic monomer (a2), the carboxyl-containing (meth)acrylic monomer (a3), and optionally additional monomers (ax) in the presence of a polymerization initiator.

For example, one, or two or more kinds of thermal polymerization initiators may be used as the polymerization initiators. Examples thereof include peroxide initiators such as benzoyl peroxide and lauroyl peroxide, and azo initiators such as azobisisobutyronitrile.

The adhesive composition of the present invention includes a tackifier resin (B). One, or two or more kinds of tackifier resins may be used. Examples thereof include rosin resins such as unmodified rosins, modified rosins and rosin derivatives; terpene resins such as unmodified terpenes, aromatic modified terpenes, hydrogenated terpenes and terpenephenols; polymer resins such as petroleum resins, coumarone-indene resins and pure monomer petroleum resins; and condensed resins such as phenol resins and xylene resins.

One, or two or more kinds of unmodified rosins may be used. Examples thereof include gum rosin, wood rosin and tall oil rosin.

One, or two or more kinds of modified rosins may be used. Examples thereof include disproportionated rosins, polymerized rosins and hydrogenated rosins.

One, or two or more kinds of rosin derivatives may be used. Examples thereof include rosin esters obtained by esterifying the unmodified rosins or the modified rosins described above; unsaturated fatty acid-modified rosins obtained by modifying the unmodified rosins or the modified rosins with unsaturated fatty acids; unsaturated fatty acid-modified rosin esters obtained by modifying the rosin esters described above with unsaturated fatty acids; rosin alcohols obtained by reducing the carboxyl group in the unsaturated fatty acid-modified rosins or the unsaturated fatty acid-modified rosin esters described above; rosin metal salts such as metal salts of the unmodified rosins, the modified rosins, the rosin esters, the unsaturated fatty acid-modified rosins, the unsaturated fatty acid-modified rosin esters or the rosin alcohols; and rosin phenols.

One, or two kinds of unmodified terpenes may be used. Examples thereof include polymers of terpene compounds such as α-pinene, β-pinene, d-limonene, l-limonene and dipentene.

One, or two or more kinds of aromatic modified terpenes may be used. Examples thereof include phenol-modified products and styrene-modified products of the unmodified terpenes described above.

One, or two or more kinds of terpene phenols may be used. Examples thereof include resins obtained by copolymerizing terpenes and phenols.

One, or two or more kinds of petroleum resins may be used. Examples thereof include aliphatic petroleum resins, aromatic petroleum resins, aliphatic/aromatic petroleum resins and hydrogenated products thereof.

In particular, the tackifier resin (B) may comprise a rosin resin. The proportion of the rosin resin (preferably a rosin derivative, more preferably a rosin ester, and still more preferably a modified rosin ester) in the tackifier resin(s) (B) is preferably not less than 40 mass %, more preferably not less than 50 mass %, and still more preferably not less than 55 mass %, and is preferably 100 mass % or less, more preferably not more than 85 mass %, and still more preferably not more than 75 mass %.

In addition to the rosin resin, the tackifier resins (B) may include a tackifier resin (preferably a petroleum resin) other than the rosin resins. The content of the tackifier resin other than the rosin resins is preferably not less than 10 parts by mass, more preferably not less than 30 parts by mass, and still more preferably not less than 50 parts by mass, and is preferably not more than 100 parts by mass, more preferably not more than 80 parts by mass, and still more preferably not more than 70 parts by mass, with respect to 100 parts by mass of the rosin resin.

Commercially available tackifier resins may be used. Examples of the commercial rosin resins include PINECRYSTAL series KR-85, KR-612 and KR-614 (all manufactured by ARAKAWA CHEMICAL INDUSTRIES, LTD.); RONDIS series R—CH, K-25, K-80 and N-18 (all manufactured by ARAKAWA CHEMICAL INDUSTRIES, LTD.); Shiragiku Rosin, ARDYME R-95 and PINECRYSTAL KR-140 (all manufactured by ARAKAWA CHEMICAL INDUSTRIES, LTD.); HYPALE CH (manufactured by ARAKAWA CHEMICAL INDUSTRIES, LTD.); ESTER GUM series AA-G, AA-L, AAV, 105 and AT, PENSEL series GA-100 and AZ, and PINECRYSTAL KE-359 (all manufactured by ARAKAWA CHEMICAL INDUSTRIES, LTD.), HARIESTER series TF and S, NEOTALL G2, and HARITACK series 8LJA and ER95 (all manufactured by Harima Chemicals Group, Inc.); ESTER GUM series H and HP, and PINECRYSTAL series KE-311 and PE-590 (all manufactured by ARAKAWA CHEMICAL INDUSTRIES, LTD.); PINECRYSTAL KE-100 (manufactured by ARAKAWA CHEMICAL INDUSTRIES, LTD.); PENSEL series C, D-125, D-135, D-160 and KK, SUPER ESTER series E-650, E-788, E-865 and E-865NT (all manufactured by ARAKAWA CHEMICAL INDUSTRIES, LTD.), HARIESTER series SK-323NS, SK-508, SK-508H, SK-816E and SK-822E, and HARITACK PCJ (all manufactured by Harima Chemicals Group, Inc.); PINECRYSTAL series KE-604 and KR-120 (all manufactured by ARAKAWA CHEMICAL INDUSTRIES, LTD.); TAMANOL series E-100, E-200 and E-200NT (all manufactured by ARAKAWA CHEMICAL INDUSTRIES, LTD.); and PINECRYSTAL series KM-1500 and KR-50M (all manufactured by ARAKAWA CHEMICAL INDUSTRIES, LTD.). Examples of the polymer resins include FTR0100, FTR2120, FTR2140, FTR6100, FTR6110, FTR6125, FTR7100, FTR8100, FTR8120 and FMR0150 (all manufactured by Mitsui Chemicals, Inc.).

In particular, hydrogenated rosin resins such as PINECRYSTAL series KE-100, KE-311, PE-590 and KE-359 are preferable.

In the adhesive composition of the present invention, the content of the tackifier resin (B) is preferably not less than 10 parts by mass, more preferably not less than 15 parts by mass, and still more preferably not less than 20 parts by mass, and is preferably not more than 100 parts by mass, more preferably not more than 80 parts by mass, and still more preferably not more than 60 parts by mass, with respect to 100 parts by mass of the acrylic polymer (A).

The adhesive composition of the present invention includes a crosslinking agent (C). One, or two or more kinds of crosslinking agents may be used. Examples thereof include isocyanate crosslinking agents, epoxy crosslinking agents, aziridine crosslinking agents, polyvalent metal salt crosslinking agents, metal chelate crosslinking agents, keto hydrazide crosslinking agents, oxazoline crosslinking agents, carbodiimide crosslinking agents, silane crosslinking agent, and glycidyl (alkoxy)epoxysilane crosslinking agents.

In particular, isocyanate crosslinking agents, epoxy crosslinking agents, oxazoline crosslinking agents, carbodiimide crosslinking agents, and glycidyl (alkoxy)epoxysilane crosslinking agents are preferable. Isocyanate crosslinking agents, epoxy crosslinking agents and carbodiimide crosslinking agents are more preferable. Isocyanate crosslinking agents are particularly preferable.

The proportion of the isocyanate crosslinking agent is preferably not less than 50 mass %, more preferably not less than 80 mass %, and still more preferably not less than 90 mass %, and is preferably 100 mass % or less of the crosslinking agent(s) (C).

The content of the crosslinking agent (C) is preferably not less than 0.1 part by mass, more preferably not less than 0.3 parts by mass, and still more preferably not less than 0.5 parts by mass, and is preferably not more than 10 parts by mass, more preferably not more than 7 parts by mass, and still more preferably not more than 5 parts by mass, with respect to 100 parts by mass of the acrylic polymer (A).

The adhesive composition of the present invention preferably includes a solvent (D). One, or two or more kinds of solvents (D) may be used. Examples thereof include aromatic hydrocarbon solvents such as toluene and xylene; ester solvents such as ethyl acetate and butyl acetate; ketone solvents such as acetone and methyl ethyl ketone; and aliphatic hydrocarbon solvents such as hexane. In particular, it is preferable that the solvent comprise an ester solvent.

The proportion of the ester solvent is preferably not less than 50 mass %, more preferably not less than 80 mass %, and still more preferably not less than 90 mass %, and is preferably 100 mass % or less of the solvent(s) (D).

The content of the solvent (D) in the adhesive composition is preferably not less than 10 mass %, more preferably not less than 30 mass %, and still more preferably not less than 50 mass %, and is preferably not more than 90 mass %, more preferably not more than 70 mass %, and still more preferably not more than 65 mass %.

The adhesive composition of the present invention may contain additives, for example, bases (ammonia water and the like) or acids for adjusting the pH; foaming agents; plasticizers; softeners; oxidation inhibitors; fillers such as glass or plastic fibers, balloons or beads, and metal powders; colorants such as pigments and dyes; pH adjusters; film-forming auxiliaries; leveling agents; thickeners; water repellents; anti-foaming agents; acid catalysts; and acid generators.

An adhesive layer may be formed by applying the adhesive composition onto a support and drying the coating. The support may be any substrate such as a substrate of a release sheet or an adhesive sheet.

Some example coating techniques are knife coaters, reverse coaters, die coaters, lip die coaters, slot die coaters, gravure coaters and curtain coaters.

The thickness of the adhesive layer is preferably not less than 5 μm, more preferably not less than 10 μm, and still more preferably not less than 15 μm, and is preferably not more than 100 μm, more preferably not more than 70 μm, and still more preferably not more than 50 μm.

An adhesive sheet or an adhesive tape of the present invention includes the adhesive layer and the substrate described above. For example, the substrate may be any of a film, a sheet, a tape, a plate or a three-dimensional shape. Some example substrate materials are plastics such as polyester resins, polypropylene resins, polyethylene resins, polyimide resins, polyvinyl chlorides and urethane resins; rubbers; nonwoven fabrics; metal foils; and papers, with plastics being preferable, and polyvinyl chlorides being more preferable. Further, the substrate may have a smooth surface, or may have a textured surface as is the case of a fibrous substrate, a foam substrate or the like.

The thickness of the substrate is preferably not less than 0.1 μm, and is preferably not more than 1,000 μm.

### EXAMPLES

Hereinbelow, the present invention will be described in more detail with reference to EXAMPLES.

### Synthetic Example 1

### Synthesis of Acrylic Resin (A)

A reaction vessel equipped with a stirrer, a reflux condenser, a nitrogen inlet tube and a thermometer was loaded with 885 parts by mass of 2-ethylhexyl acrylate, 10 parts by mass of acrylic acid, 100 parts by mass of diacetoneacrylamide, 5 parts by mass of 4-hydroxyethyl acrylate and 1000 parts by mass of ethyl acetate. The mixture was heated to 70° C. while performing stirring and blowing nitrogen. After 1 hour, there was added 10 parts (5% in terms of solid) of a solution of 2,2′-azobis(2-methylbutyronitrile) in ethyl acetate. Thereafter, the mixture was held at 70° C. for 8 hours while performing stirring. The contents were then cooled and filtered through a 200-mesh wire net. An acrylic resin (A) was thus obtained which had a nonvolatile content of 50 mass %, a viscosity of 100,000 mPa·s, and a weight average molecular weight of 800,000.

### Example 1

100 Parts by mass of the acrylic resin (A) obtained in SYNTHETIC EXAMPLE 1 was mixed together with 15 parts by mass of tackifier resin 1 (PINECRYSTAL PE-590; manufactured by ARAKAWA CHEMICAL INDUSTRIES, LTD.), 10 parts by weight of tackifier resin 2 (FTR6125; manufactured by Mitsui Chemicals, Inc.), and 0.75 parts by mass of a polyisocyanate crosslinking agent (FINETACK Hardener D-40; manufactured by DIC CORPORATION). The mixture was stirred uniformly to give an acrylic adhesive composition.

### Examples 2 to 11

Adhesive compositions were obtained in the same manner as in EXAMPLE 1, except that the types and amounts of the nitrogen functional group-containing monomer and the carboxyl-containing monomers in the acrylic resin, and the types and amounts of the tackifier resins and the crosslinking agent used in EXAMPLE 1 were changed as described in Table 1.

The molecular weight was measured as a polystyrene-equivalent molecular weight under the following conditions. Measurement device: High-performance GPC device (“HLC-8220GPC” manufactured by TOSOH CORPORATION) Columns: The following columns from TOSOH CORPORATION connected in series were used.

“TSKgel G5000” (7.8 mm ID×30 cm)×1

“TSKgel G4000” (7.8 mm ID×30 cm)×1

“TSKgel G3000” (7.8 mm ID×30 cm)×1

“TSKgel G2000” (7.8 mm ID×30 cm)×1

Detector: RI (differential refractometer)
Column temperature: 40° C.

### Eluent: Tetrahydrofuran (THF)

Flow rate: 1.0 mL/min
Injection volume: 100 μL (0.4 mass % solution of sample in tetrahydrofuran)
Standard samples: A calibration curve was prepared using the following standard polystyrenes.

### (Standard Polystyrenes)

“TSKgel Standard Polystyrene A-500” manufactured by TOSOH CORPORATION

“TSKgel Standard Polystyrene A-1000” manufactured by TOSOH CORPORATION

“TSKgel Standard Polystyrene A-2500” manufactured by TOSOH CORPORATION

“TSKgel Standard Polystyrene A-5000” manufactured by TOSOH CORPORATION

“TSKgel Standard Polystyrene F-1” manufactured by TOSOH CORPORATION

“TSKgel Standard Polystyrene F-2” manufactured by TOSOH CORPORATION

“TSKgel Standard Polystyrene F-4” manufactured by TOSOH CORPORATION

“TSKgel Standard Polystyrene F-10” manufactured by TOSOH CORPORATION

“TSKgel Standard Polystyrene F-20” manufactured by TOSOH CORPORATION

“TSKgel Standard Polystyrene F-40” manufactured by TOSOH CORPORATION

“TSKgel Standard Polystyrene F-80” manufactured by TOSOH CORPORATION

“TSKgel Standard Polystyrene F-128” manufactured by TOSOH CORPORATION

“TSKgel standard polystyrene F-288” manufactured by TOSOH CORPORATION

“TSKgel standard polystyrene F-550” manufactured by TOSOH CORPORATION

### Comparative Examples 1 to 3

Adhesive compositions were obtained in the same manner as in EXAMPLE 1, except that the amounts of the nitrogen functional group-containing monomer in the acrylic resin, and of the tackifier resins used in EXAMPLE 1 were changed as described in Table 1.

### [Adhesive Film Preparation Method]

The adhesive compositions obtained in EXAMPLES and COMPARATIVE EXAMPLES were each applied onto the surface of a 25 μm thick polyethylene terephthalate film having a release-treated surface (release-treated PET 25) so that the film thickness after the drying of the solvent would be 25 μm. The solvent was volatilized in a dryer at 80° C. for 3 minutes. A soft vinyl chloride substrate was attached to each of the films.

### [Method for Measuring Bond Strength]

The adhesive films fabricated as described above were cut to give 25 mm wide test pieces. Adherends were a SUS 304 stainless steel plate having a BA finished surface (bright annealed after cold rolling) and a PP (polypropylene) plate. The test pieces were attached to the adherends by being pressed against the adherend with a 2 kg roller two times back and forth. One hour after the application, the 180-degree peel strength was measured in an atmosphere at 23° C. and 50% RH to evaluate the bond strength. The results are described in Table 1.

The bond strength immediately after preparation was evaluated as ◯ when the measured values were 18 N/25 mm or more with respect to SUS and 13 N/25 mm or more with respect to PP, and was evaluated as X when the measured values were less than these limits.

### [Method for Evaluating Plasticizer Resistance]

The bond strength retention was calculated as follows and was evaluated as ⊙ when the ratio was 80% or more, ◯ 70% or more, and X less than 70%. The results are described in Table 1.

$$Bond strength retention ( \% ) = \frac{\begin{matrix}Bond strength of adhesive sheet after \\ storage at 60 ° C . and 90 \% RH for 4 days\end{matrix}}{\begin{matrix}Bond strength of adhesive sheet \\ immediately after preparation\end{matrix}} \times 100 \qquad [ Math . 1 ]$$

TABLE 1

| | | | | EXAMPLES | | | | | | | |
|---|---|---|---|---|---|---|---|---|---|---|---|
| | | | | 1 | 2 | 3 | 4 | 5 | 6 | 7 | 8 |
| Amounts | Acrylic adhesives | (a1) | 2EHA | 88.5 | 92.5 | | | | 92.5 | | |
| (parts by | | | BA | | | 88.5 | 92.5 | 92.5 | | 92.5 | 92.5 |
| mass) | | | MA | | | | | | | | |
| | | (a2) | DAAM | 10 | 6.0 | | | | 6.0 | | |
| | | | NIPAM | | | 10.0 | | | | | |
| | | | DMAA | | | | 6.0 | | | 6.0 | |
| | | | HEAA | | | | | 6.0 | | | 6.0 |
| | | (a3) | AA | 1.0 | 1.0 | 1.0 | 1.0 | 1.0 | 1.0 | 1.0 | 1.0 |
| | | (ax) | 4HBA | 0.5 | 0.5 | 0.5 | 0.5 | 0.3 | 0.5 | 0.5 | 0.5 |
| | | Solvent | Ethyl acetate | 100 | 100 | 100 | 100 | 100 | 100 | 100 | 100 |
| | Tackifier resins | Rosins | PE-590 | 30 | 30 | 30 | 30 | 30 | | | |
| | | | KE-100 | | | | | | 30 | | |
| | | | PCJ | | | | | | | 30 | |
| | | | A-100 | | | | | | | | 30 |
| | | | MHDR | | | | | | | | |
| | | Styrene | FTR6125 | 20 | 20 | 20 | 20 | 20 | 20 | 20 | 20 |
| | | Terpenes | PX-1000 | | | | | | | | |
| | | | T-115 | | | | | | | | |
| | Crosslinking agents | Isocyanate | D-40 | 1.5 | 1.5 | 1.5 | 1.5 | 1.5 | 1.5 | 1.5 | 1.5 |
| | | Epoxy | E-2C | | | | | | | | |
| Evaluations | Bond strength | [N/25 mm] | SUS | 22 | 20 | 20 | 24 | 20 | 21 | 24 | 18 |
| | immediately after | | PP | 16 | 17 | 18 | 15 | 15 | 18 | 18 | 15 |
| | preparation | | | | | | | | | | |
| | Bond strength after | [N/25 mm] | SUS | 18 | 17 | 17 | 20 | 16 | 17 | 20 | 14 |
| | durability test | | PP | 15 | 14 | 15 | 12 | 12 | 16 | 15 | 13 |

| | | | | | | | | | |
|---|---|---|---|---|---|---|---|---|---|
| Bond strength retention | SUS | 82% | 85% | 85% | 83% | 80% | 81% | 83% | 78% |
| | PP | 94% | 82% | 83% | 80% | 80% | 89% | 83% | 87% |
| Bond strength (initial) | | ◯ | ◯ | ◯ | ◯ | ◯ | ◯ | ◯ | ◯ |
| Bond strength retention | | ⊙ | ⊙ | ⊙ | ⊙ | ⊙ | ⊙ | ⊙ | ◯ |

| | | | | | | | COMPARATIVE | | |
|---|---|---|---|---|---|---|---|---|---|
| | | | | EXAMPLES | | | EXAMPLES | | |
| | | | | 9 | 10 | 11 | 1 | 2 | 3 |
| Amounts | Acrylic adhesives | (a1) | 2EHA | 88.5 | 88.5 | 88.5 | | 88.45 | 88.45 |
| (parts by | | | BA | | | | 97.42 | | |
| mass) | | | MA | | | | | | |
| | | (a2) | DAAM | | | 10 | | 10 | 10 |
| | | | NIPAM | 10.0 | 5.0 | | | | |
| | | | DMAA | | | | | | |
| | | | HEAA | | | | | | |
| | | (a3) | AA | 1.0 | 3.0 | 1.0 | 2.0 | 1.5 | 1.5 |
| | | (ax) | 4HBA | 0.5 | 0.5 | 0.5 | 0.06 | 0.05 | 0.05 |
| | | Solvent | Ethyl acetate | 100 | 100 | 100 | 100 | 100 | 100 |
| | Tackifier resins | Rosins | PE-590 | 15 | | 30 | 30 | | |
| | | | KE-100 | | | | | | |
| | | | PCJ | | 15 | | | | |
| | | | A-100 | | 20 | | | | |
| | | | MHDR | | 15 | | | | |
| | | Styrene | FTR6125 | 20 | | 20 | 20 | | |
| | | Terpenes | PX-1000 | | | | | | 10 |
| | | | T-115 | | | | | | 20 |
| | Crosslinking agents | Isocyanate | D-40 | 1.5 | 1.5 | | 1.5 | 1.5 | 1.5 |
| | | Epoxy | E-2C | | | 1.5 | | | |
| Evaluations | Bond strength | [N/25 mm] | SUS | 18 | 22 | 18 | 21 | 10 | 15 |
| | immediately after | | PP | 14 | 17 | 14 | 19 | 10 | 15 |
| | preparation | | | | | | | | |
| | Bond strength after | [N/25 mm] | SUS | 15 | 16 | 16 | 14 | 8.0 | 13.0 |
| | durability test | | PP | 12 | 13 | 12 | 13 | 8.3 | 13 |

| | | | | | | | |
|---|---|---|---|---|---|---|---|
| Bond strength retention | SUS | 83% | 73% | 89% | 67% | 80% | 87% |
| | PP | 86% | 76% | 86% | 68% | 83% | 87% |
| Bond strength (initial) | | ◯ | ◯ | ◯ | ◯ | X | X |
| Bond strength retention | | ⊙ | ◯ | ⊙ | X | ⊙ | ⊙ |

In Table 1, BA denotes n-butyl acrylate, MA methyl acrylate, NIPAM N-isopropylacrylamide, DMAA dimethylacrylamide, and HEAA hydroxyethylacrylamide. Further, PE-590 denotes “PINECRYSTAL PE-590” (manufactured by ARAKAWA CHEMICAL INDUSTRIES, LTD.), KE-100 “PINECRYSTAL KE-100” (manufactured by ARAKAWA CHEMICAL INDUSTRIES, LTD.), PCJ “HARITACK PCJ” (manufactured by Harima Chemicals Group, Inc.), A-100 “SUPER ESTER A-100” (manufactured by ARAKAWA CHEMICAL INDUSTRIES, LTD.), MHDR “M-HDR” (manufactured by Wuzhou Sun Shine Forestry & Chemicals CO., Ltd. Of Guangxi), FTR6125 “FTR6125” (Manufactured by Mitsui Chemicals, Inc.), PX-1000 “YS Resin PX1000” (manufactured by YASUHARA CHEMICAL CO., LTD.), and T-115 “YS POLYSTER T115” (manufactured by YASUHARA CHEMICAL CO., LTD.). The epoxy crosslinking agent used was “FINETACK Hardener E-2C” (manufactured by DIC CORPORATION).

EXAMPLES 1 to 11 according to the present invention involved an acrylic polymer including a nitrogen-containing (meth)acrylic monomer and a carboxyl-containing (meth)acrylic monomer. It is probable that hydrogen-bonding interaction was produced between the two so as to inhibit the migration of the plasticizer from the vinyl chloride substrate.

Acrylic polymers which include a combination of a nitrogen-containing (meth)acrylic monomer and a carboxyl-containing (meth)acrylic monomer have a high Tg and thus, when added at a high dose, deteriorate flexibility and cause a decrease in adhesion which results in low bond strength. However, the addition of tackifier resins having good compatibility therewith enhanced the adhesion, thus making it possible to concurrently satisfy high bond strength and plasticizer migration resistance.

The concurrent satisfaction of high bond strength and plasticizer migration resistance failed in COMPARATIVE EXAMPLE 1 because the polymer did not contain units derived from a nitrogen-containing (meth)acrylic monomer, in COMPARATIVE EXAMPLE 2 because the composition did not contain tackifier resins, and in COMPARATIVE EXAMPLE 3 because the proportion of the rosin tackifier resin in the tackifier resins was below the range according to the present invention.

1. An adhesive composition comprising an acrylic polymer (A), a tackifier resin (B) and a crosslinking agent (C), wherein
the acrylic polymer (A) includes units derived from a (meth)acrylic acid alkyl ester (a1), a nitrogen-containing (meth)acrylic monomer (a2) and a carboxyl-containing (meth)acrylic monomer (a3),
the content of the tackifier resin (B) is not less than 20 mass % of the content of nonvolatile components, and
not less than 40 mass % of the tackifier resin (B) is represented by a rosin tackifier resin (b1).

2. The adhesive composition according to claim 1, wherein a (meth)acrylamide compound is included as the nitrogen-containing (meth)acrylic monomer (a2).

3. The adhesive composition according to claim 1, wherein a monomer represented by the formula (1) is included as the nitrogen-containing (meth)acrylic monomer (a2): 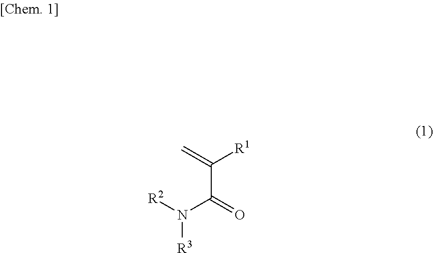
wherein R¹ denotes a hydrogen atom or a methyl group, R² and R³ each independently denote a hydrogen atom or a C1-C20 hydrocarbon group, and the hydrocarbon group may be substituted with —CO— in place of —CH₂— and may be substituted with a hydroxyl group in place of a hydrogen atom.

4. The adhesive composition according to claim 1, wherein the mass ratio ((a2)/(a3)) of the units from the nitrogen-containing (meth)acrylic monomer (a2) to the units from the carboxyl-containing (meth)acrylic monomer (a3) is not less than 1.0 and not more than 20.

5. The adhesive composition according to claim 1, wherein a hydrogenated rosin tackifier resin is included as the rosin tackifier resin (b1).

6. The adhesive composition according to claim 1, further comprising a solvent (D).

7. An adhesive layer formed from the adhesive composition described in claim 1.

8. A sheet or tape comprising a polyvinyl chloride substrate and the adhesive layer described in claim 7.

9. The adhesive composition according to claim 2, wherein a monomer represented by the formula (1) is included as the nitrogen-containing (meth)acrylic monomer (a2): 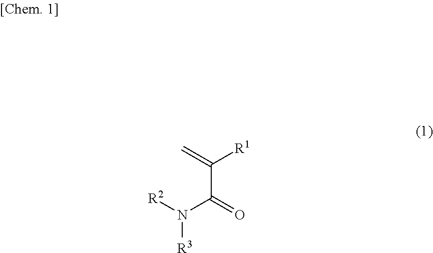
wherein R¹ denotes a hydrogen atom or a methyl group, R² and R³ each independently denote a hydrogen atom or a C1-C20 hydrocarbon group, and the hydrocarbon group may be substituted with —CO— in place of —CH₂— and may be substituted with a hydroxyl group in place of a hydrogen atom.

10. The adhesive composition according to claim 2, wherein the mass ratio ((a2)/(a3)) of the units from the nitrogen-containing (meth)acrylic monomer (a2) to the units from the carboxyl-containing (meth)acrylic monomer (a3) is not less than 1.0 and not more than 20.

11. The adhesive composition according to claim 3, wherein the mass ratio ((a2)/(a3)) of the units from the nitrogen-containing (meth)acrylic monomer (a2) to the units from the carboxyl-containing (meth)acrylic monomer (a3) is not less than 1.0 and not more than 20.

12. The adhesive composition according to claim 2, wherein a hydrogenated rosin tackifier resin is included as the rosin tackifier resin (b1).

13. The adhesive composition according to claim 3, wherein a hydrogenated rosin tackifier resin is included as the rosin tackifier resin (b1).

14. The adhesive composition according to claim 4, wherein a hydrogenated rosin tackifier resin is included as the rosin tackifier resin (b1).

15. The adhesive composition according to claim 2, further comprising a solvent (D).

16. The adhesive composition according to claim 3, further comprising a solvent (D).

17. The adhesive composition according to claim 4, further comprising a solvent (D).

18. An adhesive layer formed from the adhesive composition described in claim 2.

19. An adhesive layer formed from the adhesive composition described in claim 3.

20. An adhesive layer formed from the adhesive composition described in claim 4.
